(19) United States
(12) Patent Application Publication
(10) Pub. No.: US 2009/0199952 A1
(43) Pub. Date: Aug. 13, 2009

(54) PERSONALIZED ADHESIVE MEMOBOARD

(76) Inventor: Caroline Roque, L'Isle-Adam (FR)

Correspondence Address: 3M INNOVATIVE PROPERTIES COMPANY, PO BOX 33427, ST. PAUL, MN, 55133-3427, US

(21) Appl. No.: 12/093,557

(22) PCT Filed: Nov. 20, 2006
(86) PCT No.: PCT/US06/45020

§ 371 Date: Nov. 14, 2008

(30) Foreign Application Priority Data
Nov. 21, 2005 (GB) 0523629.4

(51) Int. Cl. B32B 37/02; B32B 37/14; B32B 33/00

(52) U.S. Cl. 156/87; 428/195.1; 428/41.8

(57) ABSTRACT

A method of making a bulletin board is provided. The method includes the steps of: (a) providing an image-bearing substrate having an image on at least one major surface; (b) providing a transparent substrate having on one major surface thereof a first pressure sensitive adhesive (PSA) that is a repositionable PSA, and having on the opposite major surface thereof a second PSA; (c) applying the transparent substrate on the image of adhering the transparent sheet thereto by the second PSA.

The present invention relates to a method for making a personalized adhesive memoboard. The invention further relates to a kit for making a personalized adhesive memoboard and to a transparent substrate for use in making an adhesive memoboard.

There are a variety of types of bulletin or memo board used in office, industrial or home situations. Some involve a fabric surface to which items may be adhered with adhesive or with microreplicated hooks. Others involve a ferromagnetic sheet such as steel and the use of magnets to hold articles in place. Articles that are placed on such bulletin boards include printed or hand written paper or card items, such as memos, photographs, newspaper cuttings, recipes, shopping lists, and the like. Items other than paper or card may be held on such boards, including, keys, coins, pencils, pens and the like. Bulletin or memoboards may be framed or unframed and may be held to the underlying surface by nails, screws, adhesive coated hook and loop systems, in addition to the aforementioned adhesives of various types.

Known bulletin boards are the Post-it® Self-Stick Bulletin Board commercially available from 3M Company, St. Paul, Minn., USA. These boards have a tacky adhesive front surface layer and are attached to surfaces by double sided pressure sensitive foam tape or hook attachment systems.

U.S. Pat. No. 3,857,731 describes a bulletin board where both front and back surfaces of the board are coated with a binder-microsphere adhesive matrix, this double-coated sheet could be utilized, for example, to form a temporary bulletin board which itself is removable from a wall or similar structure without damage to the underlying surface. It also describes a double coated transparent sheet, such as polyester film that can be temporarily applied to a window and used to attach replaceable signs, plaques, decorative objects, etc.

U.S. Pat. No. 6,780,486 describes a bulletin board assembly comprising a first sheet with a printable top surface and a lower surface coated with adhesive, combined with a first protecting sheet coated on each side with a release agent, a transparent sheet coated on each side with adhesive, and a second protecting sheet coated on each side with a release agent. In use, the top surface is printed with e.g. text or graphics, the assembly is separated between the adhesive layer of the first printed sheet and the top surface of the first protecting sheet, the lower second protecting sheet is removed, the combined first protecting sheet and transparent sheet coated on each side with adhesive is placed on top of the printed sheet, the first protecting sheet is removed, providing an adhesive layer as the top surface of the bulletin board.

The adhesive boards known in the prior art suffer from one or more disadvantages. For example, some of the adhesive boards in the prior art have a complicated structure and may be difficult to manufacture. Furthermore, the adhesive boards of the prior art typically do not allow the user to personalize the memoboard as many of the adhesive boards known in the art are provided ready-made with a layout and look provided by the manufacturer. To the extent adhesive memoboards are known in the art that allow personalization, they typically allow only limited personalization and do not allow the user to convert any image-bearing substrate into an adhesive memoboard.

It would thus be desirable to find a new method for providing a personalized adhesive memoboard. For example it would be desirable to find a method that maximizes opportunities for personalization including personalizing the memoboard in respect of the background image, size and shape of the memoboard. In particular, it would be desirable to find a method that allows the user to convert a large variety of image-bearing substrates into an adhesive memoboard. Desirable such memoboard would be temporarily and can be removed from the image-bearing substrate without causing damage thereto. Furthermore, it would be preferred to find a method that allows an image-bearing substrate to be converted into an adhesive memoboard with minimal or any visual disturbance of the image-bearing substrate, i.e. the memoboard would be hardly visible when applied over the image-bearing substrate. Desirably, the image-bearing substrate can be converted into an adhesive memoboard in an easy and convenient way.

In a first aspect, the invention provides a method of making a bulletin board, the method comprising:
providing an image-bearing substrate having an image on at least one major surface;
providing a transparent substrate having on one major surface thereof a first pressure sensitive adhesive, said first pressure sensitive adhesive being a repositionable pressure sensitive adhesive, and having on the opposite major surface thereof a second pressure sensitive adhesive;
   applying said transparent substrate on the image of said image-bearing substrate and adhering said transparent sheet thereto by said second pressure sensitive adhesive.

The term ‘image’ in connection with this invention includes any type of presentation of information including without limitation, text, letters, digits, indicia, graphics, photos, pictures as well as any combination thereof.

In a second aspect, the invention provides a kit for making a bulletin board, said kit comprising (i) at least one printable substrate having at least one major surface capable of being printed on and (ii) at least one transparent substrate having on one major surface thereof a first pressure sensitive adhesive, said first pressure sensitive adhesive being a repositionable pressure sensitive adhesive and having on the opposite major surface thereof a second pressure sensitive adhesive and wherein both of said first and second adhesives are protected with a release liner.

In yet another aspect, the invention provides a transparent substrate for making a bulletin board, said transparent substrate having on one major surface thereof a first pressure sensitive adhesive, said first pressure sensitive adhesive being a repositionable pressure sensitive adhesive and having on the opposite major surface thereof a second pressure sensitive adhesive and wherein said second pressure sensitive adhesive has a three dimensional topography comprising a series of channels for allowing fluid egress or wherein said second pressure sensitive adhesive is provided in a pattern.

The method of the present invention and transparent substrate of the present invention allow the user to transform any photograph, printed or handwritten sheet or similar, into a personalized adhesive memoboard or bulletin board, having a pressure sensitive repositionable adhesive surface to which notes, reminders and the like can be removably and repositionably attached. The invention allows a user to make a personalized memoboard in an easy and convenient way. In particular, the invention allows the user to quickly and easily apply the transparent substrate over an image-bearing substrate such as a photograph or decorated wall. This can generally be done without disturbing the visual appearance of the image-bearing substrate and without destroying or damaging the image or image-bearing substrate upon removal of the transparent substrate.

In this application the following terms may be used and are defined as follows:

“adhesion” refers to the state in which two surfaces are held together by interfacial forces, which may consist of valence forces or interlocking action, or both (Halwey's Condensed Chemical Dictionary, 11^{th} ed. Van Nostrand Reinhold, New Tork, 1987, page 23);

“backing” refers to a thin, flexible sheet which, after being placed in intimate contact with a pressure sensitive adhesive can not be subsequently removed without damaging the adhesive coating; useful adhesive articles, often called “tapes”, frequently comprise a backing and adhesive, with or without a liner, depending on the adhesive properties and interned method of use of the adhesive article;

“elastic” refers to the ability of a material to recover its original shape partially or completely after the deforming force has been removed, wherein the amount of deformation that is not recovered is called permanent set or permanent elongation;

“embossable” refers to the ability of a pressure sensitive adhesive layer or liner to have part of its surface raised or depressed in relief, especially by mechanical means;

“embossed” means a pressure sensitive adhesive layer or liner having part of its surface raised or depressed in relief;

“liner”, used interchangeably with the term “release liner” means a flexible sheet of typically paper or plastic, which after being placed in intimate contact with a pressure-sensitive adhesive surface may be subsequently removed without damaging the adhesive coating; the sheet coated may be coated on one or both surfaces with a low surface energy coating, typically a polyolefine, silicone or fluorochemical material, or a combination, thereby providing a non-stick or release surface to make it easily detachable from an adhesive layer. The release level may be equal or different for each surface.

“microscopic” refers to structures of small enough dimension so as to require an optic aid to the naked eye when viewed from any plane of view to determine its shape. One criterion is found in “Modern Optic Engineering”, by W. J. Smith, McGraw-Hill, 1966, pages 104-105, whereby visual acuity, “. . . is defined and measured in terms of the angular size of the smallest character that can be recognized”. Normal visual acuity is considered to be when the smallest recognizable letter subtends an angular height of 5 minutes or arc on the retina. At typical working distance of 250 mm (10 inches), this yields a lateral dimension of 0.36 mm (0.0145 inch) for the object;

“microstructure” means the configuration of structures wherein as least two dimensions of the structure are microscopic; the topical and/or cross-sectional view of the structures must be microscopic;

“microstructured liner” refers to a liner with at least one microstructured surface which is suitable for contact with an adhesive:

“pegs” when used alone encompasses adhesive pegs and composite pegs;

“tack” means instant contact adhesion between the adhesive and the substrate, and the tack may be substrate specific.

The transparent substrate for use in connection with the invention comprises on one major surface a first pressure sensitive adhesive. This first pressure sensitive adhesive is a repositionable pressure sensitive adhesive. By the term ‘repositionable’ here is meant that when articles, e.g. sheets of paper, are attached thereto, they can be again removed therefrom without damaging the article and the article can be attached again to the repositionable adhesive. In particular, the article can be removed and attached again multiple times (e.g. 20-50 times) without substantially affecting the adhesion of the article to the transparent substrate. Desirably, no or limited transfer of adhesive from the transparent substrate to the article occurs.

Particular examples of repositionable adhesives that may be used are those of the type used on Post-it® notes manufactured by 3M Company, St. Paul, Minn., USA. The repositionable adhesive generally comprises microsphere adhesive, for example as described in U.S. Pat. Nos. 5,824,748; 5,756,625; 5,714,237; 5,571,617; 5,045,569; 4,495,318; 4,166,152; 3,857,731; 3,691,140. Particularly suitable are the microsphere adhesives disclosed in U.S. Pat. Nos. 3,691,140 and 4,166,152. The microsphere adhesives described in these patents are infusible, organic solvent-dispersible, organic solvent-insoluble, inherently tacky and elastomeric homo- or copolymer microspheres. The microspheres will typically have a diameter in the range of 1 to 250 μm, preferably between 5 and 150 μm. The microspheres are insoluble in organic solvent and are dispersible in common organic solvents except highly polar organic solvents such as methanol and ethanol. Typically, the microspheres will be dispersible in organic solvents such as for example ethyl acetate, tetrahydrofuran, heptane, 2-butanone, benzene, cyclohexane esters, isopropanol and higher alcohols. The microspheres are generally produced via an aqueous suspension polymerization utilising an emulsifier in an amount greater than the critical micelle concentration.

In a particular embodiment, the repositionable pressure sensitive adhesive comprises copolymer microspheres that comprise 90% to 99.5% by weight of at least one alkyl acrylate ester and 10 to 0.5% by weight of at least one monomer that is selected from the group consisting of substantially oil-insoluble, water-soluble, ionic monomers and maleic anhydride. Microsphere adhesives of this composition are disclosed in U.S. Pat. No. 3,691,140. The alkyl acrylate ester portion of the microspheres generally comprises those alkyl acrylate monomers which are oleophilic, water-emulsifiable, of restricted water-solubility, and which, as homopolymers, generally have glass transition temperatures below −20° C. Examples of alkyl acrylate ester monomers that can be used include iso-octyl acrylate, 4-methyl-2-pentyl acrylate, 2-methylbutyl acrylate, sec-butyl acrylate, and the like. Acrylate monomers with glass transition temperatures higher than −20° C. (i.e. tert-butyl acrylate, iso-bornyl acrylate or the like) may be used in conjunction with one of the above described acrylate ester monomers as long as the resultant polymer has glass transition temperature less than −20° C. Additionally, the tacky nature of the microspheres can be varied by inclusion of a minor portion of a non-acrylate or methacrylate ester comonomer which is non-ionic and water insoluble, such as divinyl benzene and N-t-octylacrylamide.

The water-soluble ionic monomer portion of the microspheres is comprised of those monomers which are substantially insoluble in oil. By substantially oil-in-soluble and water-soluble it is meant that the monomer has a solubility of less than 0.5% by weight and, a distribution ratio at a given temperature (preferably 50° to 65° C.), of solubility in the oil phase monomer to solubility in the aqueous phase of less than 0.005.

Ionic monomers conforming to the preceding criteria include acrylic acid, and methacrylic acids including salts thereof such as sodium methacrylate, ammonium acrylate and sodium acrylate, (I) trimethylamine p-vinyl benzimide, (II) 4,4,9-trimethyl-4-azonia-7-oxo-8-oxa-dec-9-ene-1-sulphonate, (III) N,N-dimethyl-N-(b-methacryloxy-ethyl) ammonium propionate betaine, (IV) trimethylamine methacrylimide, (V) 1,1-dimethyl-1(2,3-dihydroxypropyl)amine methacrylimide; any zwitterionic monomer having the preceding solubility requirements, and the like.

In another embodiment, a microsphere adhesive as disclosed in U.S. Pat. No. 4,166,152 may be used. Such microsphere adhesive is based on microspheres that may consist of a homopolymer of an alkyl acrylate and that do not require the presence of an ionic comonomer as set forth above. To obtain these microspheres, U.S. Pat. No. 4,166,152 teaches the suspension polymerization of an alkyl acrylate or alkyl methacrylate ester using an emulsifier in an amount greater than the critical micelle concentration in combination with an ionic suspension stabilizer.

The repositionable microsphere pressure sensitive adhesives used on the transparent substrate may be formulated to provide different desired levels of tack and ultimate adhesion as disclosed in the aforementioned patent publications.

The transparent substrate has on the major surface opposite to the major surface having the first pressure sensitive adhesive, a second pressure sensitive adhesive. The second pressure sensitive adhesive is used to apply the transparent substrate on an image-bearing substrate. This second pressure sensitive adhesive does not need to be repositionable but generally only needs to be removable. By removable is meant that the transparent substrate can be removed from the image-bearing substrate preferably without leaving adhesive residue and without damaging the image-bearing substrate or the image thereon. Typically, the second pressure sensitive adhesive is an acrylic pressure sensitive adhesive of which the ultimate adhesion level is designed to as to meet the removability. In a particular embodiment, the second pressure sensitive adhesive is a repositionable pressure sensitive adhesive as described above. In the latter case, the ultimate adhesion level of the second pressure sensitive adhesive should be larger than that of the first pressure sensitive adhesive. For example, the second pressure sensitive adhesive, when repositionable, may have a peel strength measured under identical conditions that is at least twice, for example at least 4 times the adhesion level of the first pressure sensitive adhesive.

In a particular desirable embodiment, the second pressure sensitive adhesive is configured so as to allow air-egress during application of the transparent substrate to the image-bearing substrate. In one embodiment to provide air-egress functionality, the second pressure sensitive adhesive may be pattern coated on the transparent substrate rather than providing the second pressure sensitive adhesive as continuous adhesive layer. Hence, the pattern would include for example stripes, bands or dots where no adhesive is present. The width of such bands will generally be selected small enough to avoid possible visual disturbance of the image-bearing substrate. A width of the band may for example be less than 500 microns, for example less than 300 microns or even less than 100 microns. Also the pattern applied is not particularly limited and may be regular or irregular and may include intersecting bands or stripes.

In another embodiment to provide air-egress functionality, the second pressure sensitive adhesive is provided with a three dimensional topography of channels that allow air-egress during application of the transparent substrate. Generally, the average depth of such channels measured relative to the adhesive surface (the surface without considering the pegs described furtheron) is less than 45 microns and is typically between 1 and 20 microns, with a typical range being 3 to 10 microns. Desirable a small channel depth is used as this will minimize any possibility of visual disturbance of the image-bearing substrate. The channels may be provided in only one direction of the plane of the second pressure sensitive adhesive or they can be provided in both directions as intersecting channels. The latter will generally be advantageous to maximize air-egress. Also, the channels may be provided in a regular straight pattern or they can be provided in an irregular pattern and/or they may be provided in a wavy pattern. In a further embodiment, the rheology of the second pressure sensitive adhesive is designed such that the channels upon application or shortly thereafter close. Nevertheless, even if the channels close upon application, it will still be desirable to use a channel depth as disclosed above to avoid and minimize visual disturbance of the image-bearing substrate as different strain in the adhesive and the transparent substrate may otherwise still cause the appearance of the (closed) channel structure which may interfere with the appearance of the underlying image of the image-bearing substrate. The three-dimensional topography may be provided in the second pressure sensitive adhesive through the use of a release liner having the reverse topography as disclosed in e.g. EP 1011955 and EP 951518. Still further useful three dimensional topographies that may be used to provide air-egress are disclosed in U.S. Pat. Nos. 5,273,805; 5,462,765; 5,650,215; 5,897,930; 6,197,397; 6,524,649; 6,524,675; 6,630,218; 6,759,110.

In a particular embodiment of the present invention, easy positionability of the transparent substrate may be achieved by providing the pressure sensitive adhesive with two levels of adhesion: a low level of adhesion by initial contact with the image-bearing substrate and a higher desired final level of adhesion obtained upon firmly pressing the transparent substrate against the image-bearing substrate. The initial low level of adhesion will be generally be such to hold the transparent substrate on the image-bearing substrate while still allowing it to be peeled away and adhered again to position it. Positionability may be achieved as disclosed in e.g. U.S. Pat. Nos. 5,141,790; 5,296,277; 5,362,516; 5,795,636. Conveniently, positionability is achieved by providing adhesive or non-adhesive pegs on the surface of the pressure sensitive adhesive. Such pegs are small protrusions are for example protruding from the adhesive surface between 5 and 200 microns. Generally the pegs won't occupy more than 30% of the adhesive surface. Upon application of pressure to firmly apply the transparent substrate, the pegs will be pushed into the adhesive matrix. The pegs may be composed of adhesive material or they may consist of nonadhesive material in which case the transparent substrate can be positioned by sliding it over the image-bearing substrate. Also, the pegs may be composed of a blend of adhesive and non-adhesive materials. The pegs may be randomly distributed across the adhesive surface or they may be provided in a regular pattern. Also, the use of pegs can be advantageously combined with the use of channels as disclosed in EP 1011955 and EP 951518.

The transparent substrate for use in connection with the present invention includes clear transparent substrates as well as translucent substrate although a clear transparent substrate will generally be preferred. The transparent substrate is typically a flexible substrate. The thickness of the transparent substrate may vary widely but will typically be chosen to allow easy of handling and application and to allow suitable flexibility. Typically the transparent substrate will have a thickness of 100 microns to 300 microns. The transparent substrate is typically a clear or colored transparent polymeric film, e.g. a polyolefin such as polyethylene or polypropylene or a polyester. Alternatively, the transparent substrate can be tracing paper. The transparent substrate may be provided in sheet form or may be provide in the form of a roll. In the latter case, the user can cut the transparent substrate to desired dimensions.

The first and second pressure sensitive adhesive on the transparent substrate are typically protected with a release liner. Any release liner known in the art or suitable for use in connection with pressure sensitive adhesives may be used. When the transparent substrate is provided in roll form, one single release liner can be used to protect both the first and second pressure sensitive adhesive. However, the first and second pressure sensitive adhesive may be protected with separate liners. Generally, it will be desirable to protect the first pressure sensitive adhesive with a transparent release liner which will allow for more easy application of the transparent substrate on the image-bearing substrate as the user would be able to see the image through the transparent liner and transparent substrate while applying the latter on the image of the image-bearing substrate in connection with the method of the present invention.

Although the present invention contemplates of using the transparent substrate to provide a memo-board on a pre-existing image-bearing substrate such as for example a photograph or wall cover design, the invention also provides a kit including means to custom make an adhesive memo-board including making the image-bearing substrate. Thus, the kit in accordance with this aspect of the invention includes at least one printable substrate having at least one major surface capable of being printed on and (ii) at least one transparent substrate having on one major surface thereof a first pressure sensitive adhesive, the first pressure sensitive adhesive being a repositionable pressure sensitive adhesive and having on the opposite major surface thereof a second pressure sensitive adhesive and wherein both of the first and second adhesives are protected with a release liner.

For example, the printable substrate of the kit may be a photographic paper suitable for printing a photographic image with an inkjet printer. Accordingly, in such embodiment, the user would print an image on the photographic paper to provide the image-bearing substrate. Subsequently, the release liner of the second pressure sensitive adhesive is removed and the transparent substrate, optionally cut to desired dimensions, is applied to the image-bearing substrate, i.e. the printed image. If the first adhesive is still protected with a release liner, the method of making the memo-board would be completed upon removal of that release liner.

### BRIEF DESCRIPTION OF THE DRAWINGS

The invention is further illustrated with reference to the following schematic drawings without the intention to limit the invention thereto.

FIG. 1 represents a cross-sectional view of an embodiment of a transparent substrate according to the invention and which comprises a second pressure sensitive adhesive with a microreplicated adhesive surface.

FIG. 2 represents a cross-sectional view of a further embodiment of a transparent substrate according to the invention.

FIG. 3 represents a cross-sectional view of further embodiment of a transparent substrate according to the invention.

FIGS. 4, 5 & 6 illustrate various applications of the invention.

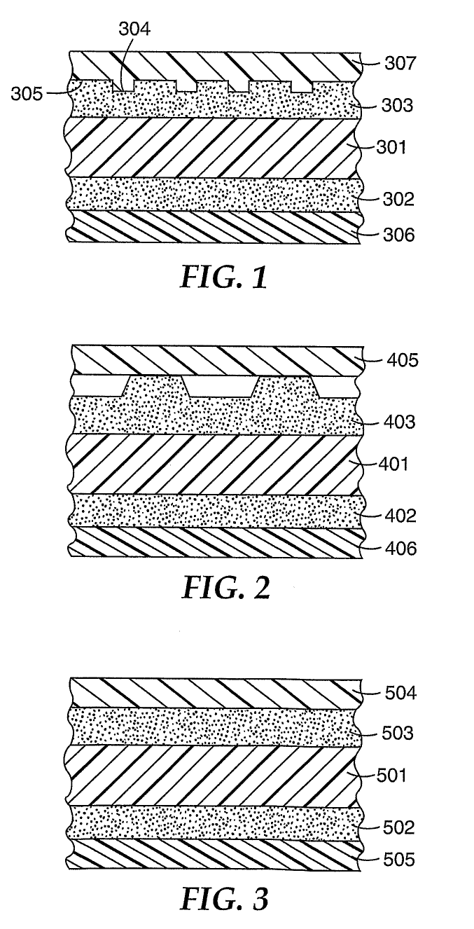

Various embodiments of the transparent substrate with first and second pressure sensitive adhesive are shown in FIGS. 1, 2, and 3.

In FIG. 1, transparent film 301 is coated on one surface with repositionable pressure sensitive adhesive microsphere adhesive 302, and on the other surface with an adhesive layer 303 that allows for the dispersion of air during application to a surface through linear depressions or “valleys” 304 in the microreplicated adhesive surface 305. Release liner 306 is attached to the top surface and release liner 307 to the bottom surface of the adhesive coated transparent film. The film 301 may be transparent or translucent (partially transparent), may be a thin translucent paper, and may be tinted with a colour or be water-white.

In use, release liner 307 is removed and the assembly attached to the desired surface. Release liner 306 remains in place and allows the user to apply the assembly to the desired surface by applying hand pressure or pressure from a roller. The preferred technique is to lightly adhere the assembly to the desired surface to allow repositioning until the desired orientation of the assembly to the underlying surface is obtained. Next pressure is applied generally from the center outwards to firmly adhere the assembly to the surface. By applying pressure from the center outward the inclusion of air bubbles is minimised or avoided. However, the microreplicated surface of the adhesive layer 303 allows air to escape via “valleys” 304, between adhesive layer 303 and the surface, further eliminating the possibility of entrapping air which can cause unsightly air bubbles. Next, release liner 306 is removed exposing the repositionable pressure sensitive adhesive microsphere adhesive layer for use as the surface of the bulletin board.

During application of pressure the “valleys” 304, may become flattened out, further reducing any visible evidence of their presence, such as lines or striations.

FIG. 2 illustrates a further embodiment of the invention. Transparent film 401 is coated on one surface with repositionable pressure sensitive adhesive microsphere adhesive 402, and on the other surface with an adhesive 403 that offers two levels of adhesion, a low contact bond on application of light bonding pressure that allows repositioning and a high final bond on the application of higher pressure, the microreplicated surface configuration of the adhesive 404 also allowing the dispersion of air during application to a surface. Release liner 405 is attached to the top surface and release liner 406 to the bottom surface of the adhesive coated transparent film.

FIG. 3 illustrates a yet further embodiment of the invention. Transparent film 501 is coated on one surface with a relatively low tack or low adhesion repositionable pressure sensitive adhesive microsphere adhesive 502, and on the other surface with a relatively higher tack repositionable pressure sensitive adhesive microsphere adhesive 503. Release liner 505 is attached to the top surface and release liner 506 to the bottom surface of the adhesive coated transparent film. This differential level of tack allows ease of removal of an item adhered to the bulletin board without removing the film from the substrate.

The pressure sensitive adhesive microsphere adhesive layer 502 may be coated in stripes or dots (not shown), further improving the air bleedability via the uncoated areas.

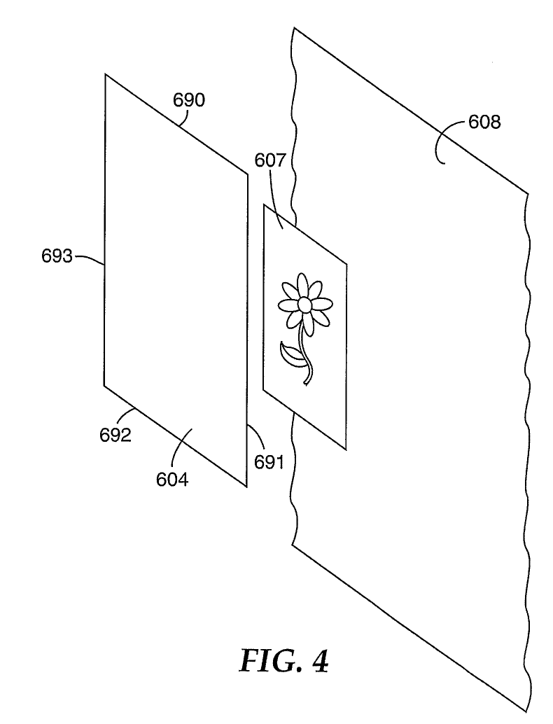

FIG. 4 illustrates an example of a use of the invention, where a photograph 607 is used as a background to a personalised bulletin board. Advantageously, the film assembly 604 is cut to be larger than the photograph so that the borders 690, 691, 692, 693 overlap the photograph firmly adhering it to the underlying substrate 608.

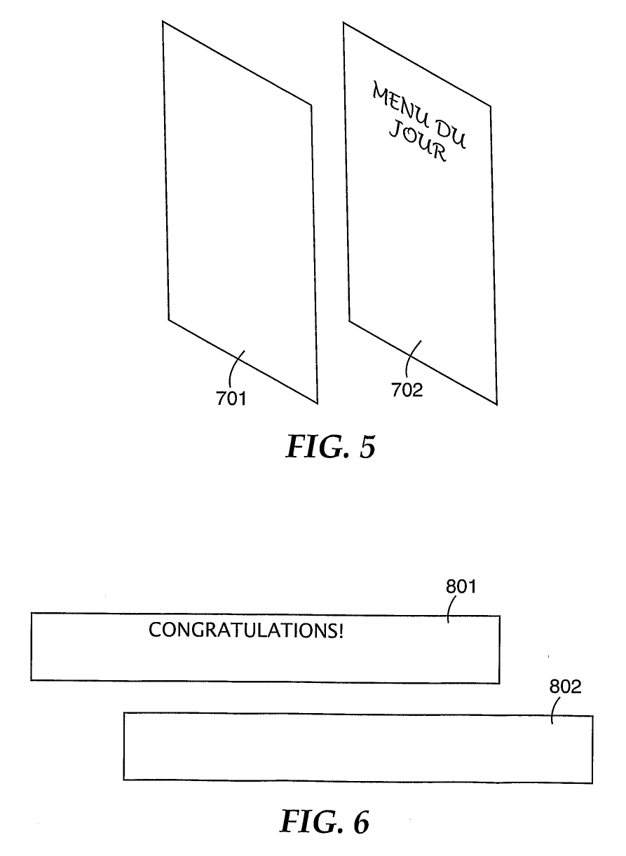

FIG. 5 illustrates a further use of the invention where, for example, a menu 701 is converted into personalised bulletin board. The adhesive article 702 as shown is cut to fit the menu, however, it could be cut larger as in the example shown in FIG. 4. Conveniently, the adhesive article could be provided in a series of conventional sizes, e.g. “A.4”, so that a menu printed on A.4 size paper or card would use a similar size adhesive article.

FIG. 6 illustrates a further use of the invention where, for example, a printed banner 801 of a non-conventional size, is converted into a personalised bulletin board. Conveniently, the adhesive article could be provided in large sheet size or in a roll form, and be cut to size. The adhesive article 802 as shown is cut to fit the banner, however, it could be cut larger as in the example shown in FIG. 4.

1.-9. (canceled)

10. A method of making a bulletin board comprising the steps of:
providing an image-bearing substrate having an image on at least one major surface;
providing a transparent substrate having on one major surface thereof a first repositionable pressure sensitive adhesive and having on the opposite major surface thereof a second pressure sensitive adhesive having a three dimensional topography comprising a series of channels for allowing fluid egress;
applying said transparent substrate on the image of said image-bearing substrate; and
adhering said transparent substrate thereto by said second pressure sensitive adhesive.

11. The method of claim 10, wherein said second pressure sensitive adhesive is provided in a pattern.

12. The method of claim 10, wherein at least one of said first and second pressure sensitive adhesive is a microsphere adhesive.

13. The method of claim 10, wherein said image-bearing substrate is a sheet and wherein an image is provided thereon by printing.

14. A kit for making a bulletin board, said kit comprising:
at least one printable substrate having at least one major surface capable of being printed on; and
at least one transparent substrate having on one major surface thereof a first pressure sensitive adhesive being a repositionable pressure sensitive adhesive and having on the opposite major surface thereof a second pressure sensitive adhesive having a three dimensional topography comprising a series of channels for allowing fluid egress, and
wherein both of said first and second adhesives are protected with a release liner.

15. The kit of claim 14 wherein said second pressure sensitive adhesive is provided in a pattern.

16. A transparent substrate for making a bulletin board, said transparent substrate having on one major surface thereof a first repositionable pressure sensitive adhesive and having on the opposite major surface thereof a second pressure sensitive adhesive having a three dimensional topography and comprising a series of channels for allowing fluid egress or wherein said second pressure sensitive adhesive is provided in a pattern.

17. The transparent substrate according to claim 16, wherein said first and second pressure sensitive adhesives are protected by a release liner.
